(19) United States
(12) Patent Application Publication
(10) Pub. No.: US 2006/0209776 A1
(43) Pub. Date: Sep. 21, 2006

(54) In-vehicle wireless communications device

(75) Inventor: Koji Shinoda, Chiryu-city (JP)

Correspondence Address: HARNESS, DICKEY & PIERCE, P.L.C., P.O. BOX 828, BLOOMFIELD HILLS, MI, 48303, US

(73) Assignee: DENSON Corporation, Kariya-city (JP)

(21) Appl. No.: 11/376,685

(22) Filed: Mar. 15, 2006

(30) Foreign Application Priority Data
Mar. 17, 2005 (JP) 2005-077192

(51) Int. Cl. H04Q 7/24

(52) U.S. Cl. 370/338; 370/465

(57) ABSTRACT

An in-vehicle wireless communications device receives an incoming signal via a wireless communications unit from the wireless communications network. When the in-vehicle battery is being discharged, the type of the incoming signal is determined. When the incoming signal is for a voice call, a packet communications, or a TV phone, no incoming process for the received incoming signal takes place. In contrast, when the incoming signal received by the wireless communications circuit from the wireless communications network is an incoming signal for a short message service that becomes a trigger for vehicle remote monitoring or vehicle remote control, an incoming process to the received incoming signal is executed.

### CROSS REFERENCE TO RELATED APPLICATIONS

This application is based on and incorporates herein by reference Japanese Patent Application No. 2005-77192 filed on Mar. 17, 2005.

### FIELD OF THE INVENTION

The present invention relates to an in-vehicle wireless communications device.

### BACKGROUND OF THE INVENTION

In vehicle remote monitoring, an incoming signal is transmitted as a trigger from a service center via a wireless communications network to an in-vehicle wireless communications device in a vehicle. Even while the vehicle is parked with an ignition signal in the OFF state and an in-vehicle battery is in a discharged state, the in-vehicle wireless communications device is powered by the in-vehicle battery to be able to receive the incoming signal. In the in-vehicle wireless communications device, when a wireless communications circuit receives the incoming signal, a CPU starts an incoming process to respond to the incoming signal. (Refer to Patent Document 1)
Patent Document 1: JP-2004-114902A

The above incoming signal received via the wireless communications network includes an incoming signal of a voice call, an incoming signal of a packet communications, an incoming signal of a TV phone, or an incoming signal of an SMS (Short Message Service). For instance, even while a vehicle is parked and no user is possibly located in the vehicle, an incoming process to any received incoming signal of a voice phone call, a packet communications, or a TV phone is executed by the CPU. In this case, the power of the in-vehicle battery may be uselessly consumed in communicating various signals with the wireless communications network, posing a problem.

In contrast, when an incoming signal of an SMS is received, the CPU is preferred to securely perform the related incoming process for the SMS incoming signal as a trigger for the vehicle remote monitoring or control.

### SUMMARY OF THE INVENTION

It is an object of the present invention to provide an in-vehicle wireless communications device capable of securely performing an incoming process for a specific incoming signal received by a wireless communications circuit via a wireless communications network while properly decreasing useless power consumption of an in-vehicle battery.

To achieve the above object, an in-vehicle wireless communications device is provided with the following: A wireless communications unit powered by an in-vehicle battery is included for receiving an incoming signal from a wireless communications network. A control unit is included to be enabled to execute an incoming process for an incoming signal received by the wireless communications unit. A discharge determining unit is included for determining whether the in-vehicle battery is being discharged. An incoming signal type determining unit is included for determining a type of an incoming signal received by the wireless communications unit. Here, in a case that an incoming signal is received by the wireless communications unit and the battery is determined to be being discharged, when the received incoming signal is determined to be not a specific incoming signal, the control unit executes no incoming process to the received incoming signal. In contrast, in a case that an incoming signal is received by the wireless communications unit and the battery is determined to be being discharged, when the received incoming signal is determined to be the specific incoming signal, the control unit executes an incoming process to the received incoming signal.

Under the above structure, when a vehicle is being parked with an in-vehicle battery being discharged and an incoming signal (e.g., for a voice call, a packet communications, or a TV phone) other than a specific incoming signal is received, any incoming process is not executed for the received incoming signal. This helps prevent the in-vehicle battery's power consumption for communicating various signals with the wireless communications network. In contrast, when a vehicle is being parked with an in-vehicle battery being discharged and a specific incoming signal (e.g., a short message service (SMS) becoming a trigger for a vehicle remote monitoring or vehicle remote control) is received, an incoming process is executed for the received incoming signal. This enables an incoming process for the specific incoming signal to be securely executed.

### BRIEF DESCRIPTION OF THE DRAWINGS

The above and other objects, features, and advantages of the present invention will become more apparent from the following detailed description made with reference to the accompanying drawings. In the drawings:

FIG. 1 is a functional block diagram of an overall structure of an in-vehicle wireless communications device according to an embodiment of the present invention; and

FIG. 2 is a flowchart diagram showing an operation according to the embodiment.

### DETAILED DESCRIPTION OF THE PREFERRED EMBODIMENTS

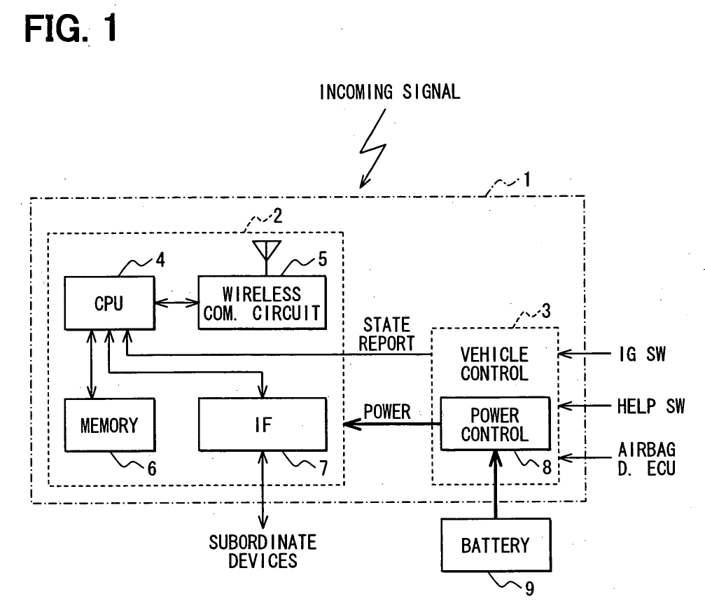

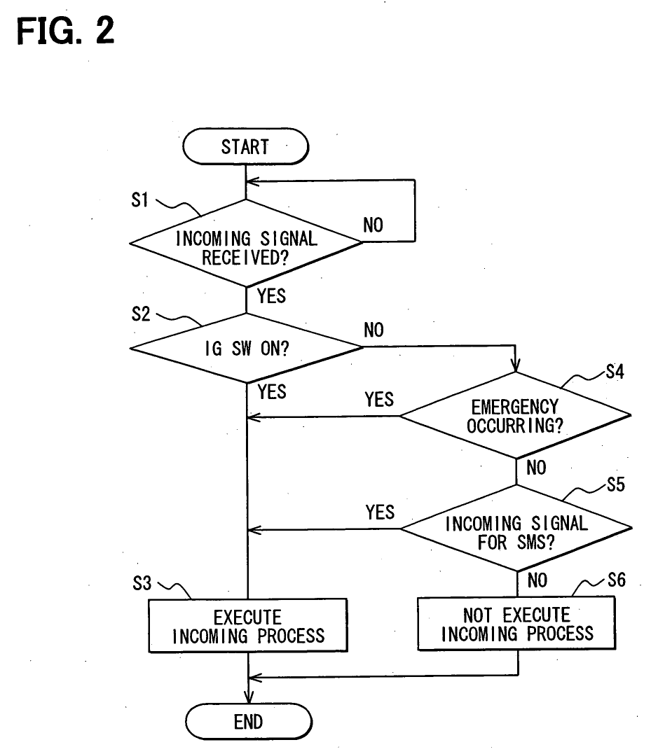

An in-vehicle wireless communications device according to an embodiment of the present invention will be explained with reference to FIGS. 1, 2. As shown in FIG. 1, an in-vehicle wireless communications device 1 includes a wireless communications module 2 and a vehicle control circuit 3. The wireless communications module 2 includes a CPU 4 as a control unit and the like, a wireless communications circuit 5 as a wireless communications unit, a memory 6, and an interface circuit 7 with peripheral subordinate devices.

The CPU 4 controls an overall operation of the wireless communications module 2 by executing a control program. The wireless communications circuit 5 receives an incoming signal from a wireless communications network and transmits a response signal or an incoming rejection signal to the incoming signal. The memory 6 stores various information necessary for the CPU 4 to execute the control program. The interface circuit 7 has a function to interface with the subordinate devices. The subordinate devices include a monitoring camera to monitor surroundings of the vehicle, an air-conditioner to control temperature in a vehicle interior, and a navigation device.

The vehicle control circuit 3 includes a power control circuit 8 that is physically directly connected with an in-vehicle battery 9. The power control circuit 8 supplies the battery power from the battery to the wireless communications module 2 to drive the CPU 4, the wireless communications circuit 5, the memory 6, and the interface circuit 7. Namely, the wireless communications circuit 5 uses the battery power from the in-vehicle battery 9 as operating power for reception operation to receive an incoming signal from the wireless communications network and transmission operation to transmit a response signal or an incoming rejection signal to the incoming signal.

The vehicle control circuit 3 receives an ignition signal from an ignition (IG) switch, a help signal from a help switch, and an airbag detection signal from an airbag detection ECU. The ignition signal indicates whether the IG switch is in the ON state or the OFF state. The help signal indicates whether a user manipulates the help switch or not. The airbag detection signal indicates whether the airbag is expanded or not. The vehicle control circuit 3 transmits a state report signal indicating an input state of each of the ignition signal, the help signal, and the airbag detection signal.

Next, an operation of the above structure will be explained with reference to FIG. 2. The flowchart in FIG. 2 is executed by the CPU 4. In this embodiment, a short message service (SMS) incoming signal is transmitted from a service center to become a trigger for a vehicle remote control or vehicle remote monitoring: the SMS incoming signal is previously designated as a specific incoming signal.

In a case that the battery power is supplied from the power control circuit 8, the CPU 4 determines whether an incoming signal is received by the wireless communications circuit 5 from the wireless communications network (Step S1). When determining that an incoming signal is received by the wireless communications circuit 5 (Step S1: YES), the CPU determines whether the ignition switch is in the ON state or OFF state (i.e., whether the battery 9 is not in a discharged state) by determining the ON state or the OFF state of the ignition signal based on a state report signal inputted from the vehicle control circuit 3.

When determining that the ignition signal is in the ON state (i.e., the battery 9 is not in the discharged state (Step S2: YES), the CPU 4 executes any incoming process for an incoming signal received by the wireless communications circuit 5 regardless of types of the incoming signals (Step S3).

In contrast, when determining that the ignition signal is in the OFF state (i.e., the battery 9 is in the discharged state (Step S2: NO), the CPU 4 determines whether an emergency state is occurring (Step S4). Specifically, the CPU 4 determines whether the help signal is in the ON state or OFF state based on the state report signal and simultaneously whether the airbag detection signal is in the ON state or OFF state, and thereby determines whether a user manipulates the help switch and simultaneously whether an airbag is expanded.

When determining that the help signal is in the ON state or that the airbag detection signal is in the ON state to thereby determine that an emergency is occurring (Step S4: YES), the CPU 4 also executes any incoming process to an incoming signal received by the wireless communications circuit 5 regardless of types of the incoming signals (Step S3).

In contrast, when determining that the help signal is in the OFF state and also that the airbag detection signal is in the OFF state to thereby determine that an emergency is not occurring (Step S4: NO), the CPU 4 determines the type of the incoming signal received by the wireless communications circuit 5 to thereby determine whether the incoming signal is an SMS incoming signal becoming a trigger for the vehicle remote monitoring or vehicle remote control (Step S5).

When determining that the incoming signal is for the SMS (Step S5: YES), the CPU 4 also executes an incoming process to the incoming signal for the SMS (Step S3). Thereafter, the CPU 4 can execute vehicle remote monitoring such as photographing surroundings of the vehicle by outputting a monitoring instruction signal to the monitoring camera via the interface circuit 7, or vehicle remote control such as controlling vehicle interior temperatures to a given temperature by outputting a control instruction signal to the air-conditioner via the interface circuit 7.

In contrast, when determining that the incoming signal is not for the SMS but for a voice phone call, a packet communications, or a TV phone (Step S5: NO), the CPU 4 thereafter executes none of processes for the incoming signal of the voice call, the packet communications, or the TV phone, received by the wireless communications circuit 5 from the wireless communications network by discarding the incoming signal without causing the wireless communications circuit 5 to transmit a response signal or an incoming rejection signal to the wireless communications network (Step S6).

In the above explanation, the SMS incoming signal is previously designated as the specific incoming signal. However, depending on the application or use, any one of incoming signals can be designated as a specific incoming signal. Further, the vehicle remote monitoring is explained by referring to photographing surroundings of the vehicle, while the vehicle remote control is explained by referring to controlling vehicle interior temperatures. However, other monitoring or control can be performed, such as outputting an alarm for warding off a suspicious individual or reading out data stored in the navigation device, respectively.

As explained above, according to the embodiment, the in-vehicle wireless communications device 1 operates as follows: An incoming signal is received from the wireless communications network; when the in-vehicle battery 9 is being discharged, the type of the incoming signal is determined; and, when the incoming signal is for a voice call, a packet communications, or a TV phone, no incoming process for the received incoming signal takes place. Therefore, the power of the battery 9 is not consumed for transmitting and receiving signals with the wireless communications network, thereby properly decreasing the useless consumption of the in-vehicle battery 9. In contrast, when the incoming signal received by the wireless communications circuit 5 from the wireless communications network is for the SMS, an incoming process to the incoming signal is executed. This allows the incoming process for the SMS incoming signal becoming a trigger for the vehicle remote monitoring or vehicle remote control to be securely executed.

Furthermore, the in-vehicle wireless communications device 1 operates as follows: An incoming signal is received from the wireless communications network; when the in-vehicle battery 9 is determined to be being discharged and also when an emergency is occurring such as user's manipulating the help switch or airbag's expanding, an incoming process to any incoming signal is executed regardless of the type of the incoming signal received from the wireless communications network. A vehicle accident may cause the in-vehicle battery 9 to become in a discharged state against a user's intention. In this case, the user may manipulate the help switch or the airbag may expand, thereby generating an emergency state. Here, for instance, an incoming process to an incoming signal of a voice call from an emergency assistance service center can be performed to thereafter receive assistance by voice from the center.

Furthermore, in the in-vehicle wireless communications device 1, no execution of incoming process to the incoming signal is achieved by causing no response signal or no incoming rejection signal. This can dispense with electric power for transmitting the response signal or incoming rejection signal to the wireless communications network, resulting in more decrease in the power consumption of the in-vehicle battery 9.

Without liming to the above embodiment, modifications or extensions can be made.

Whether the in-vehicle battery is being discharged can be also determined based on an input state of an accessory signal in stead of an input state of the ignition signal. Namely, when the accessory switch is on the OFF state, that the in-vehicle battery is being discharged can be determined.

Furthermore, the steps in the flowchart in FIG. 2 may be constructed as means or units in the program stored in a memory of the CPU.

It will be obvious to those skilled in the art that various changes may be made in the above-described embodiments of the present invention. However, the scope of the present invention should be determined by the following claims.

What is claimed is:

1. An in-vehicle wireless communications device, comprising:
a wireless communications unit powered by an in-vehicle battery to receive an incoming signal from a wireless communications network;
a control unit enabled to execute an incoming process to an incoming signal received by the wireless communications unit;
a discharge determining unit for determining whether the in-vehicle battery is being discharged; and
an incoming signal type determining unit for determining a type of an incoming signal received by the wireless communications unit; wherein
when an incoming signal is received by the wireless communications unit and the battery is determined to be being discharged,
the control unit executes no incoming process to the received incoming signal when the received incoming signal is determined to be not a specific incoming signal, whereas
the control unit executes an incoming process to the received incoming signal when the received incoming signal is determined to be the specific incoming signal.

2. The in-vehicle wireless communications device of claim 1, further comprising:
an emergency state determining unit for determining whether an emergency is occurring, wherein
when an incoming signal is received by the wireless communications unit, the battery is determined to be being discharged, and the emergency state is determined to be occurring,
the control unit executes an incoming process to the received incoming signal regardless of the type of the received incoming signal.

3. The in-vehicle wireless communications device of claim 2, wherein,
when an incoming signal is received by the wireless communications unit and the battery is determined to be discharged,
the control unit executes no incoming process to the received incoming signal when the received incoming signal is determined to be not the specific incoming signal only when the emergency state is determined to be not occurring, whereas
the control unit executes an incoming process to the received incoming signal when the received incoming signal is determined to be the specific incoming signal.

4. The in-vehicle wireless communications device of claim 1, wherein,
the wireless communications unit transmits a response signal to an incoming signal using battery power of the in-vehicle battery, and
the control unit executes no incoming process to the received incoming signal by not transmitting, to the wireless communications network, a response signal to the received incoming signal.

5. The in-vehicle wireless communications device of claim 1, wherein,
the wireless communications unit transmits an incoming rejection signal to an incoming signal using battery power of the in-vehicle battery, and
the control unit executes no incoming process to the received incoming signal by not transmitting, to the wireless communications network, an incoming rejection signal to the received incoming signal.
